(19) United States
(12) Patent Application Publication
(10) Pub. No.: US 2004/0128154 A1
(43) Pub. Date: Jul. 1, 2004

(54) Methods and apparatus for providing consumer assistance

(76) Inventor: Mary Jane Crain, Fairfax, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/476,266

(22) PCT Filed: Apr. 30, 2002
(86) PCT No.: PCT/US02/13428

(51) Int. Cl. G06F 17/60

(52) U.S. Cl. 705/1

(57) ABSTRACT

Providing consumer assistance comprises receiving an assistance request from a consumer, the assistance request comprising at least one of a request for advice from an expert, a request for advice from another consumer, and a request for advice on an available service. Next, providing consumer assistance comprises providing advice from an expert if the assistance request comprises the request for advice from an expert, providing advice from another consumer if the assistance request comprises the request for advice from another consumer, or providing advice on an available service if the assistance request comprises the request for advice on an available service.

### RELATED APPLICATIONS

Under provisions of 35 U.S.C. § 119(e), Applicant claims the benefit of U.S. provisional application No. 60/286,989, filed Apr. 30, 2001, which is incorporated herein by reference.

### TECHNICAL FIELD

The present invention relates to the field of providing consumer assistance. More particularly, the present invention, in various specific embodiments, involves methods and systems for providing consumer assistance by providing a communications hub for consumers.

### BACKGROUND

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages. In the context of electronic commerce, a consumer of item delivery services may need assistance, for example, consumers of item delivery services may desire specific information regarding interfacing with the item delivery system.

Therefore, the need to efficiently provide consumer assistance has become a common need for the United States Postal Service and many other organizations. More specifically, efficiently providing consumer assistance by providing a communications hub for consumers has become a critical service for many delivery system operators. This is because in an increasingly competitive environment, meeting and exceeding the expectations of those who receive a service is essential for a service provider.

One solution to consumer assistance problem is for the item delivery system operator to provide a call center for consumer assistance. In this situation, a consumer of item delivery service simply calls a telephone number, waits for a service representative to answer, and poses a request for assistance to the service representative.

Great inefficiencies are created in this procedure because, for example, the service representative may not be expert enough to provide sufficient assistance. Accordingly, efficiently providing consumer assistance remains an elusive goal. Thus, there remains a need for efficiently providing consumer assistance. In addition, there remains a need for efficiently providing consumer assistance by providing a communications hub for consumers.

### SUMMARY OF THE INVENTION

In accordance with the current invention, a consumer assistance method and system are provided that avoid the problems associated with prior art consumer assistance methods and systems as discussed herein above.

In one aspect, a method for providing consumer assistance comprises receiving an assistance request from a consumer, the assistance request comprising at least one of a request for advice from an expert, a request for advice from another consumer, and a request for advice on an available service, providing advice from an expert if the assistance request comprises the request for advice from an expert, providing advice from another consumer if the assistance request comprises the request for advice from another consumer, and providing advice on an available service if the assistance request comprises the request for advice on an available service.

In another aspect, a system for providing consumer assistance, comprises a component for receiving an assistance request from a consumer, the assistance request comprising at least one of a request for advice from an expert, a request for advice from another consumer, and a request for advice on an available service, a component for providing advice from an expert if the assistance request comprises the request for advice from an expert, a component for providing advice from another consumer if the assistance request comprises the request for advice from another consumer, and a component for providing advice on an available service if the assistance request comprises the request for advice on an available service.

In yet another aspect, a computer-readable medium on which is stored a set of instructions for providing consumer assistance, which when executed perform stages comprising receiving an assistance request from a consumer, the assistance request comprising at least one of a request for advice from an expert, a request for advice from another consumer, and a request for advice on an available service, providing advice from an expert if the assistance request comprises the request for advice from an expert, providing advice from another consumer if the assistance request comprises the request for advice from another consumer, and providing advice on an available service if the assistance request comprises the request for advice on an available service.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of a system for providing item delivery service consistent with an embodiment of the present invention;

FIG. 2 is a functional block diagram of an exemplary system for providing consumer assistance consistent with an embodiment of the present invention;

FIG. 3 is a functional block diagram of an exemplary consumer assistance system consistent with an embodiment of the present invention;

FIG. 4 is an illustration of types of service that may be provided by an exemplary consumer assistance system consistent with an embodiment of the present invention;

FIG. 5 is a flow chart of an exemplary method for providing consumer assistance consistent with an embodiment of the present invention; and

FIG. 6 is a flow chart of an exemplary subroutine used in the exemplary method of FIG. 5 for providing advice consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with an embodiment of the present invention, a system for providing consumer assistance comprises a component for receiving an assistance request from a consumer, the assistance request comprising at least one of a request for advice from an expert, a request for advice from another consumer, and a request for advice on an available service, a component for providing advice from an expert if the assistance request comprises the request for advice from an expert, a component for providing advice from another consumer if the assistance request comprises the request for advice from another consumer, and a component for providing advice on an available service if the assistance request comprises the request for advice on an available service.

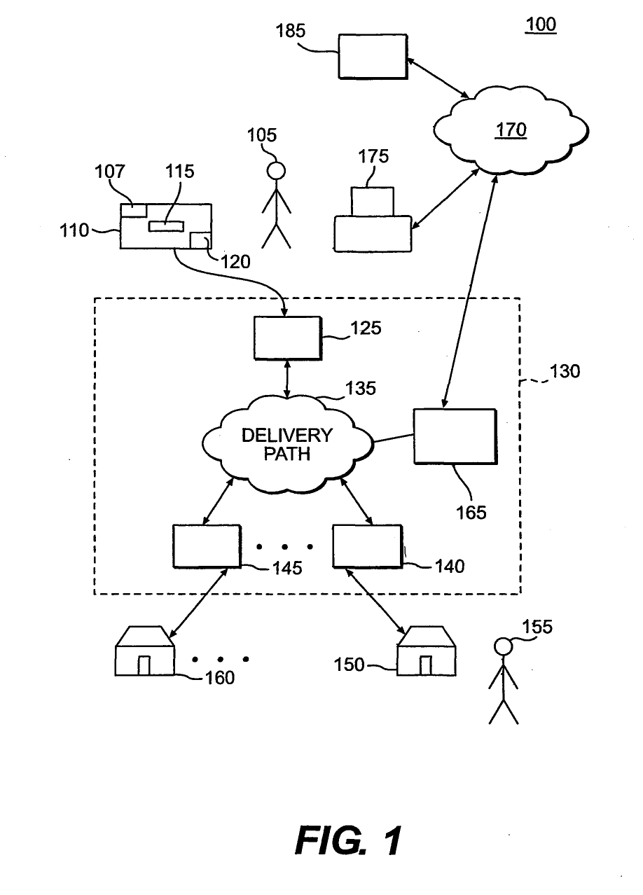

Consistent with an embodiment of the present invention, the component for receiving, the component for providing advice from an expert, the component for providing advice from another consumer, and the component for providing advice on an available service may comprise a consumer computer 175, or a consumer assistance system 185, both of which are shown in FIG. 1 and described below. Those of ordinary skill in the art, however, will appreciate that other elements of an item delivery system 100 (as shown in FIG. 1 and discussed below) may comprise the component for receiving, the component for providing advice from an expert, the component for providing advice from another consumer, and the component for providing advice on an available service.

In addition, consumer assistance system 185 may be operated by an item delivery system operator. However, those of ordinary skill in the art will appreciate that other entities or enterprises may operate consumer assistance system 185.

Referring to FIG. 1, an embodiment consistent with the present invention provides item delivery system 100. For example, a consumer 105 may place an item 110 into a delivery system 130. Item 110 may contain a label 115 indicating a first address 150 of a recipient 155 and a return address 107 indicating where to return item 110 if necessary. Item 110 may also contain a tracking indicia relating consumer 105 and recipient 155. Tracking indicia 120 may be placed on item 110 by consumer 105 or the delivery system operator.

Item 110 may be routed through delivery system 130, which may comprise a consumer plant 125, a delivery path 135, a first address plant 140, an alternative address plant 145, and an alternative processing point 165. Delivery path 135 may comprise a plurality of plants similar to consumer plant 125, first address plant 140, and alternative address plant 145. The plants within delivery path 135 may contain, among other things, automated systems and sorting equipment and are designed to receive and process a plurality of items. Delivery system 130 may be configured to sense tracking indicia 120 placed on item 110 as it passes through the elements of delivery system 130 directing the movement of item 110 through delivery system 130. In addition to facilitating the tracking of item 110 through delivery system 130, tracking indicia 120 identifies the sales transaction and relates recipient 155 and consumer 105.

Tracking indicia 120 may comprise a bar code or a PLANET code. A bar code is a printed code used for recognition by a bar code scanner (reader). Traditional one-dimensional bar codes use the bar's width to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, system operators sorted flat mail using POSTNET, a 12-digit barcode consisting of alternating long and short bars indicating the destination of, for example, a mailpiece. Responding to the expanding needs of users, particularly heavy volume users, PLANET code was developed on the foundation of the existing technical infrastructure. The PLANET Code is the opposite of the current POSTNET codes, reversing long bars for short and short bars for long. This innovation offers the convenience of a bar code that is easily applied using current bar-coding methods, and is readily scanned by the high-speed automation equipment already located in the plurality of plants comprising delivery system 130.

Item 110 may be sent through delivery system 130 by consumer 105 to first address plant 140. At anytime in the delivery process a determination may be made as to whether item 110 is undeliverable. If it is determined that item 110 is undeliverable, item 110 may be forwarded to alternative processing point 165 where an ancillary service may be performed. Examples of such ancillary services are recycle service (treating item 110 as waste), NIXIE service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 110 is undeliverable-as-addressed, address correction service (re-label with a correct address) or return service (return item to the sender) may be performed. In this case, a NIXIE operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of consumer 105. This address indicates where consumer 105 wants item 110 returned if it is undeliverable. In addition return address 107 may indicate where consumer 105 will receive a bill for any fees due for the return of item 110. When item 110 requires address correction service, a NIXIE operator obtains the proper address of recipient 155 or the reason for non-delivery. While NIXIE processing may comprise address correction service or return service, those skilled in the art will appreciate that may other types of NIXIE processing may be performed.

Computerized forwarding service is a centralized, computerized address label-generating operation that forwards undeliverable-as-addressed items to recipients. In this case, recipient 155 may pre-register an alternative address 160 of recipient 155 with the delivery system operator in order to have all items forwarded to alternative address 160. For example, if recipient 155 moves and wishes to have items sent to alternative address 160, recipient 155 notifies the delivery system operator of alternative address 160. Once the delivery system operator is notified of alternative address 160, all items sent to first address 150 are detected by delivery system 130, re-labeled, and then forwarded to alternative address 160. In the aforementioned computerized forwarding service, items are forwarded only for a specific period of time. The delivery system operator expects recipient 155 to contact each and every consumer who recipient 155 may expect to receive an item and notify the possible consumers of the address change of recipient 155. After the computerized forwarding service time period is complete, the delivery system operator will cease forwarding items to recipient 155 and will return to the consumer 105 all items sent to first address 150.

If ancillary services were required, item 110 may remain at alternative processing point 165 or may be processed at an item recovery section of alternative processing point 165. Item 110 may be recovered by consumer 105 or recipient 155 upon the completion of a tracer. A tracer is a form completed by consumer 105 or recipient 155 to locate delayed or undelivered items. While item recovery may occur at alternative processing point 165, those skilled in the art will appreciate that may other types of processing may be performed at alternative processing point 165.

While consumer assistance system 185 is shown to be separate from delivery system 130, the functionality of consumer assistance system 185 may be performed under the control of the delivery system operator at alternative processing point 165, at any point within delivery system 130, or at any point outside delivery system 130. Moreover, the functionality of consumer assistance system 185 may be performed by an enterprise not under the control of the delivery system operator.

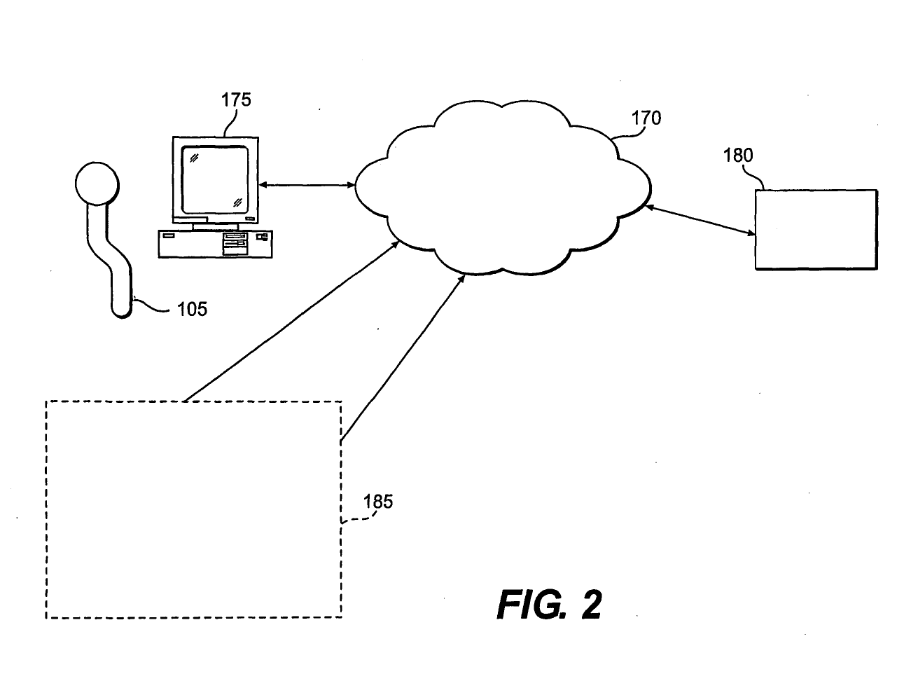

As herein embodied and illustrated in FIG. 2, elements of system 100 comprising consumer computer 175, communication system 170, and consumer assistance system 185 with be described in greater detail. Consumer computer 175 may comprise a personal computer or other similar microcomputer-based workstation. Those skilled in the art, however, will appreciate that consumer computer 175 may comprise any type of computer operating environment such as hand-held devices, multiprocessor systems, microprocessor-based or programmable consumer electronics, minicomputers, mainframe computers, and the like. Consumer computer 175 may also be practiced in distributed computing environments where tasks are performed by remote processing devices. Furthermore, consumer computer 175 may comprise a mobile terminal such as a smart phone, a cellular telephone, a cellular telephone utilizing wireless application protocol (WAP), personal digital assistant (PDA), intelligent pager, portable computer, a hand held computer, a conventional telephone, or a facsimile machine. Those skilled in the art will appreciate that consumer computer 175 may comprise other systems or devices.

A PDA is a handheld computer that serves as an organizer for personal information. It generally includes at least a name and address database, a to-do list, and a note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions.

WAP is a standard for providing cellular phones, pagers and other handheld devices with secure access to e-mail and text-based Web pages. It provides a complete environment for wireless applications that includes a wireless counterpart of TCP/IP and a framework for telephony integration such as call control and phone book access. Wireless Markup Language (WML), which is a streamlined version of HTML for small screen displays, is featured in WAP. WAP uses WMLScript, a compact language that runs in limited memory, and supports handheld input methods such as keypads and voice recognition. In addition, WAP is independent of the air interface and runs over all the major wireless networks. Moreover, it is also device independent, requiring only a minimum functionality in the unit so that it can be used with many different phones and handheld devices.

Consumer computer 175 may be located in a home, office, store, an item delivery counter within a store, a retail center kiosk, an item delivery system office, or any location wherein it may be operated. Moreover, consumer computer 175 may be operated by consumer 105 that may comprise a subject receiving advice, a technician, an advice advisor, a sales consultant, a sales person, or any other person. Those skilled in the art will appreciate that consumer computer 175 may be located at a variety of places and operated by a variety of people.

Communication system 170 may comprise, for example, a local area network (LAN) or a wide area network (WAN). Such networking environments are commonplace in offices, enterprise-wide computer networks, intranets, and the Internet, and are known by those skilled in the art. When a LAN is used as communication system 170, consumer computer 175 and elements of consumer assistance system 185 may be connected to communication system 170 through a network interface located at each of the respective consumer computer 175 and elements of consumer assistance system 185. When a WAN networking environment is utilized as communication system 170, consumer computer 175 and elements of consumer assistance system 185 typically include an internal or external modem (not shown) or other means for establishing communications over the WAN, such as the Internet.

In addition to utilizing a wire line communications system as communication system 170, a wireless communications system, or a combination of wire line and wireless may be utilized as communication system 170 in order to, for example, exchange web pages via the internet, exchange e-mails via the Internet, or for utilizing other communications channels. Wireless can be defined as radio transmission via the airwaves, however, those skilled in the art will appreciate that various other communication techniques can be used to provide wireless transmission including infrared line of sight, cellular, microwave, satellite, packet radio and spread spectrum radio. Consumer computer 175 and elements of consumer assistance system 185 in the wireless environment can be any mobile terminal such as a cellular phone, personal digital assistant (PDA), intelligent pager, portable computer, hand held computer, or any device capable of receiving wireless data. Wireless data may include, but is not limited to, paging, text messaging, e-mail, Internet access and other specialized data applications specifically excluding or including voice transmission.

In utilizing communication system 170, data sent over communication system 170 may be encrypted to insure data security. When encrypting, the data may be converted into a secret code for transmission over a public network. The original file, or “plaintext,” may be converted into a coded equivalent called “ciphertext” via an encryption algorithm executed, for example, on consumer computer 175 or on elements of consumer assistance system 185. The ciphertext is decoded (decrypted) at a receiving end and turned back into plaintext.

The encryption algorithm may use a key, which is a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are two main cryptographic methods that may be suitable for use with system 100. The traditional method uses a secret key, such as the Data Encryption Standard (DES). In DES, both sender and receiver use the same key to encrypt and decrypt. This is the fastest method, but transmitting the secret key to the recipient in the first place is not secure. The second method is public-key cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pgp.com) may be utilized in this embodiment. PGP was developed by Phil Zimmermann, founder of the company, and it is based on the RSA cryptographic method. A version for personal, non-business use is available on various Internet hosts. While PGP may be used to encrypt data transmitted over communication system 170, those skilled in the art will appreciate that many other types of encryption algorithms, methods and schemes may be employed.

In system 100, data may be transmitted by methods and processes other than, or in combination with communication system 170. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

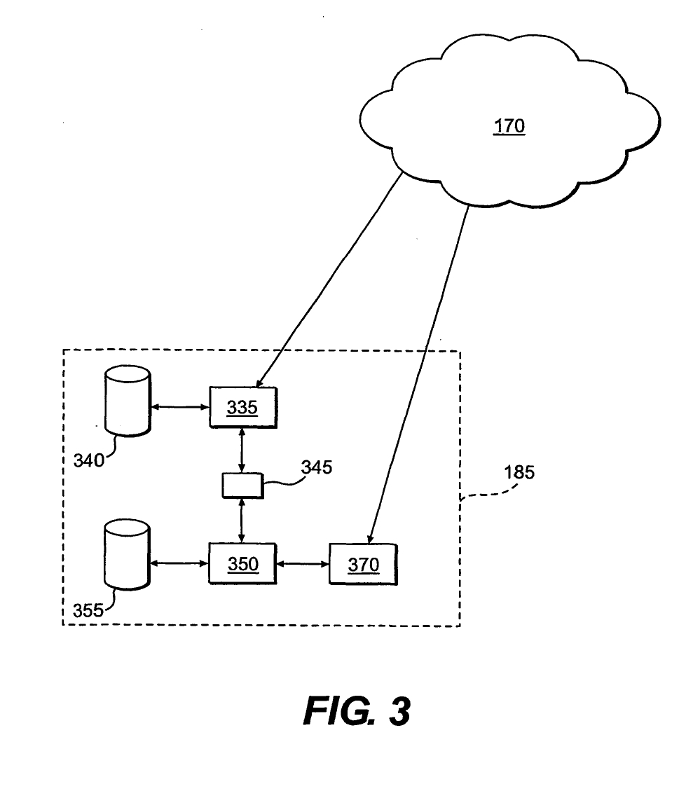

Referring to FIG. 3, exemplary consumer assistance system 185 may comprise a first server front end 335 with its associated first server front end database 340, a first server back end 350 with its associated first server back end database 355, and a simple mail transfer protocol (SMTP) server 370. Those skilled in the art will appreciate that this particular architecture of consumer assistance system 185 is exemplary, and that many other types of systems or architectures may be employed to implement consumer assistance system 185.

In exemplary consumer assistance system 185, first server front end 335 is separated from first server back end 350 by a first server firewall 345. One function of first server front end 335 is to provide an interface via communication system 170 between consumer computer 175 and consumer assistance system 185. The function of the SMTP server 370 is to provide, for example, an e-mail interface via communication system 170 between consumer computer 175 and consumer assistance system 185.

Simple mail transfer protocol is a standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming e-mail until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 335 and first server back end 350 may comprise a personal computer or other similar microcomputer-based workstations. Those skilled in the art, however, will appreciate that first server front end 335 and first server back end 350 may comprise any type of computer operating environment such as hand-held devices, multiprocessor systems, microprocessor-based or programmable consumer electronics, minicomputers, mainframe computers, and the like. First server front end 335 and first Server back end 350 may also be practiced in distributed computing environments where tasks are performed by remote processing devices. Specifically, embodiments of first server front end 335 may utilize a COMPAQ PROLIANT 1600 server running WINDOWS 2000 and DOMINO Webserver. Similarly, first server back end 350 may be implemented on a COMPAQ PROLIANT 1600 server running NT4 and DOMINO Application Server. And SMTP server 370 may be implemented on a COMPAQ DL 360 running WINDOWS 2000 and DOMINO SMTP Mail Server.

Other servers, such as an auxiliary server 180 shown in FIG. 2, may be included in system 100. Other servers used in system 100 may be constructed in an architecture similar to consumer assistance system 185 or may be constructed using other suitable architectures as are known by those skilled in the art.

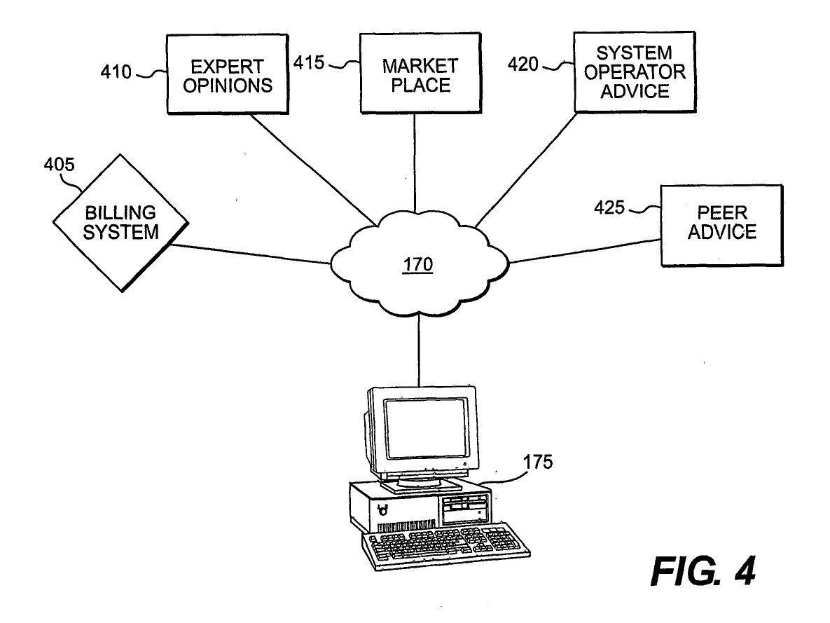

As illustrated by FIG. 4, many types of services may be provided to consumer computer 175. These service may comprise, but are not limited to, for example, billing services 405 for charging a fee to consumer 105 for assistance, expert opinions 410 that may comprise advice from experts, market place services 415 that may comprise advice on other services available, system operator advice 420 that may comprise advice specific to the operator of system 130, and peer advice 425 that may comprise advice from other consumers or customers of item delivery system 130. Those of ordinary skill in the art will appreciate many other types of service may be offered to consumer computer 175.

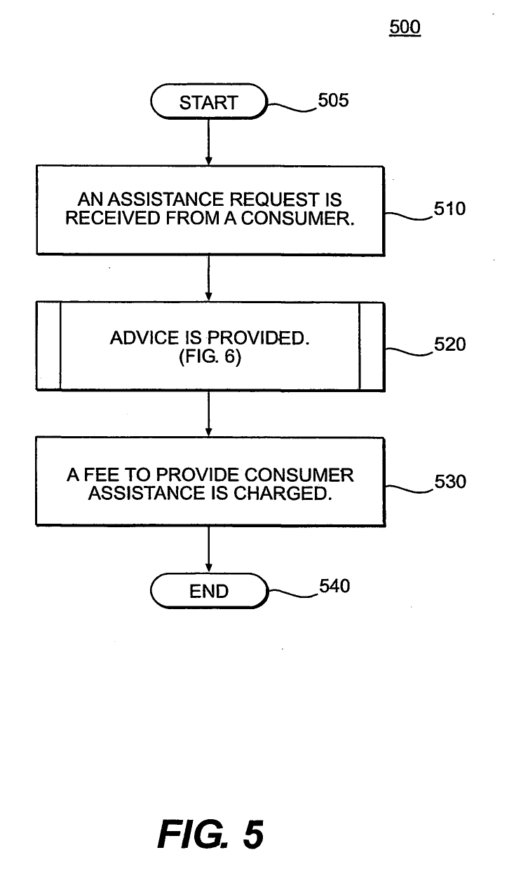

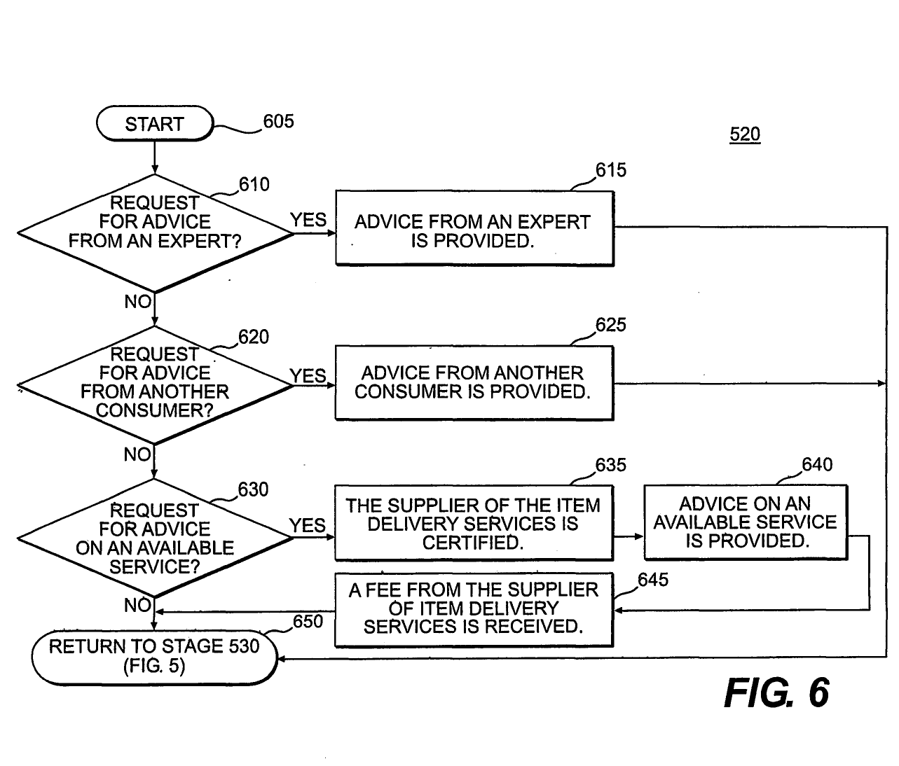

FIG. 5 is a flow chart setting forth the general stages involved in exemplary method 500 for providing consumer assistance. The implementation of the stages of exemplary method 500 in accordance with an exemplary embodiment of the present invention will be described in greater detail in FIG. 6. Exemplary method 500 begins at starting block 505 and proceeds to stage 510 where an assistance request is received from consumer 105. For example, consumer 105 may utilize consumer computer 175 to communicate the assistance request to consumer assistance system 185 over communication system 170. The assistance request may be limited to assistance regarding interfacing with item delivery system 130, for example, information on bulk mailing if item delivery system 130 comprises the United States Postal Service. In addition, if item delivery system 130 comprises the United States Postal Service, item 110 delivered in item delivery system 130 may comprise a mailpiece, a United States Postal Service Priority Mail package, or a United States Postal Service Express Mail Package. Those of ordinary skill in the art will appreciate that other item delivery system may be used and other types of items may be delivered.

From stage 510 where the assistance request is received from consumer 105, exemplary method 500 continues to exemplary subroutine 520 where advice is provided. For example, advice may be provided utilizing regular mail, e-mail, facsimile, internet, or an interactive voice response. Specifically, providing consumer assistance may include utilizing a video, providing the video over the Internet, for example. Moreover, the operator of consumer assistance system 185 may require consumer 105 to view a video before allowing consumer 105 to speak to a consumer services representative regarding a matter. Those of ordinary skill in the art will appreciate that video may be provided in way other than using the Internet. The stages of exemplary subroutine 520 are shown in FIG. 6 and will be described in greater detail below.

Once advice is provided in exemplary subroutine 520, exemplary method 500 advances to stage 530 where a fee to provide consumer assistance is charged. For example, charging the fee may comprise billing consumer 105, debiting consumer's 105 checking account, debiting consumer's 105 credit card account, debiting consumer's 105 debit card account, or receiving cash from consumer 105. Moreover, the billing may be performed over communication system 170.

After a fee to provide consumer assistance is charged in stage 530, exemplary method 500 ends at stage 540.

FIG. 6 describes exemplary subroutine 520 from FIG. 5 for providing advice. Exemplary subroutine 520 begins at starting block 605 and advances to decision block 610 where it is determined if the assistance request comprises the request for advice from an expert. For example, consumer 105 may communicate the assistance request over communication system 170.

From decision block 610, if it is determined that the assistance request comprises the request for advice from an expert, exemplary subroutine 520 advances to stage 615 where advice from an expert is provided. For example, if consumer 105 desired information on lowering the cost of bulk mailing, the expert advice may comprise information on discounts for presorting bulk mail, thus providing advice on how to send items through item delivery system 130 at a reduced cost. Those of ordinary skill in the art will appreciate that there are may other ways to reduce item delivery cost.

If at decision block 610, however, it was determined that the assistance request does not comprise the request for advice from an expert, exemplary subroutine 520 continues to decision block 620 where it is determined if assistance request comprises the request for advice from another consumer. For example, one such request may comprise advice on software purchases or other items.

From decision block 620, if it is determined that the assistance request comprises the request for advice from another consumer, exemplary subroutine 520 advances to stage 625 where advice from another consumer is provided. For example, providing advice from another consumer may comprise utilizing an electronic bulletin board or an Internet chat room provided through communication system 170.

If at decision block 620, however, it was determined that the assistance request does not comprise the request for advice from another consumer, exemplary subroutine 520 continues to decision block 630 where it is determined if the assistance request comprises the request for advice on an available service. For example, a service may comprise preparing and packaging an object for delivery through delivery system 130.

From decision block 630, if it is determined that the assistance request comprises the request for advice on an available service, exemplary subroutine 520 advances to stage 635 where the supplier of the available service is certified. For example, the delivery system operator may research the quality and overall value a particular supplier of preparing and packaging services possesses. If such quality and overall value reach a certain threshold, then the delivery system operator may certify the supplier for quality and value.

After the supplier of the item delivery services is certified in stage 635, exemplary subroutine 520 continues to stage 640 where advice on an available service is provided. For example, this advice may be provided using communication system 170.

Once advice on an available service is provided in stage 640, exemplary subroutine 520 continues to stage 645 where a fee from the supplier of item delivery services is received. For example, in exchange for providing or certifying a particular supplier of item delivery services, the supplier of item delivery services may be charged a fee for consumer 105 being provided with information regarding the particular supplier of item delivery services.

If at decision block 630, however, it was determined that the assistance request does not comprise the request for advice on an available service, or from stage 645 after a fee from the supplier of item delivery services is received, exemplary subroutine 520 continues to stage 650 and returns to stage 530 of FIG. 5.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for providing consumer assistance, comprising:
receiving an assistance request from a consumer, the assistance request comprising at least one of a request for advice from an expert, a request for advice from another consumer, and a request for advice on an available service;
providing advice from an expert if the assistance request comprises the request for advice from an expert;
providing advice from another consumer if the assistance request comprises the request for advice from another consumer; and
providing advice on an available service if the assistance request comprises the request for advice on an available service.

2. The method of claim 1, wherein providing advice from the expert further comprises providing advice on how to send items through an item delivery system at a reduced cost.

3. The method of claim 1, wherein providing advice from another consumer further comprises utilizing at least one of an electronic bulletin board and an Internet chat room.

4. The method of claim 1, wherein providing advice on the available service further comprises providing information on a supplier of item delivery services.

5. The method of claim 4, further comprising receiving a fee from the supplier of item delivery services in order for the supplier of item delivery services to be included in the advice provided.

6. The method of claim 4, further comprising certifying the supplier of the item delivery services as being a reputable enterprise.

7. The method of claim 1, further comprising utilizing at least one of regular mail, e-mail, facsimile, internet, and an interactive voice response method in providing consumer assistance.

8. The method of claim 1, further comprising charging a fee to provide consumer assistance.

9. The method of claim 8, wherein charging the fee comprises at least one of billing the consumer, debiting the consumer's checking account, debiting the consumer's credit card account, debiting the consumer's debit card account, and receiving cash from the consumer.

10. The method of claim 1, wherein the assistance request is limited to assistance regarding interfacing with an item delivery system.

11. The method of claim 10, wherein the item delivery system comprises the United States Postal Service.

12. The method of claim 10, wherein an item delivered in the item delivery system comprises at least one of a mailpiece, a United States Postal Service Priority Mail package, and a United States Postal Service Express Mail Package.

13. The method of claim 1, wherein providing consumer assistance includes utilizing a video.

14. The method of claim 13, further comprising providing the video over the Internet.

15. The method of claim 13, further comprising requiring the consumer to view the video before allowing the consumer to speak to a consumer services representative.

16. A system for providing consumer assistance, comprising:
a component for receiving an assistance request from a consumer, the assistance request comprising at least one of a request for advice from an expert, a request for advice from another consumer, and a request for advice on an available service;
a component for providing advice from an expert if the assistance request comprises the request for advice from an expert;
a component for providing advice from another consumer if the assistance request comprises the request for advice from another consumer; and
a component for providing advice on an available service if the assistance request comprises the request for advice on an available service.

17. The system of claim 16, wherein the component for providing advice from an expert provides advice on how to send items through an item delivery system at a reduced cost.

18. The system of claim 16, wherein the component for providing advice from another consumer utilizes at least on of an electronic bulletin board and an Internet chat room.

19. The system of claim 16, wherein the component for providing advice on an available service provides information on a supplier of item delivery services.

20. The system of claim 19, wherein a fee is received from the supplier of item delivery services in order for the supplier of item delivery services to be included in the advice provided.

21. The system of claim 19, wherein the supplier is certified as being a reputable enterprise.

22. The system of claim 16, wherein at least one of regular mail, e-mail, facsimile, internet, and an interactive voice response system in is used to do at least one of receive the assistance request and provide the advice.

23. The system of claim 16, wherein a fee is charged to provide consumer assistance.

24. The system of claim 23, wherein at least one of billing the consumer, debiting the consumer's checking account, debiting the consumer's credit card account, debiting the consumer's debit card account, and receiving cash from the consumer is used to charge the fee.

25. The system of claim 16, wherein the assistance request is limited to assistance regarding interfacing with an item delivery system.

26. The system of claim 25, wherein the item delivery system comprises the United States Postal Service.

27. The system of claim 25, wherein an item delivered in the item delivery system comprises at least one of a mailpiece, a United States Postal Service Priority Mail package, and a United States Postal Service Express Mail Package.

28. The system of claim 16, wherein a video is used to provide the consumer assistance.

29. The system of claim 28, wherein the video is provided over the Internet.

30. The system of claim 28, wherein the consumer is required to view the video before the consumer is allowed to speak to a consumer services representative.

31. A computer-readable medium on which is stored a set of instructions for providing consumer assistance, which when executed perform stages comprising:
receiving an assistance request from a consumer, the assistance request comprising at least one of a request for advice from an expert, a request for advice from another consumer, and a request for advice on an available service;
providing advice from an expert if the assistance request comprises the request for advice from an expert;
providing advice from another consumer if the assistance request comprises the request for advice from another consumer; and
providing advice on an available service if the assistance request comprises the request for advice on an available service.

32. The computer-readable medium of claim 31, wherein providing advice from the expert further comprises providing advice on how to send items through an item delivery system at a reduced cost.

33. The computer-readable medium of claim 31, wherein providing advice from another consumer further comprises utilizing at least on of an electronic bulletin board and an Internet chat room.

34. The computer-readable medium of claim 31, wherein providing advice on the available service further comprises providing information on a supplier of item delivery services.

35. The computer-readable medium of claim 34, further comprising receiving a fee from the supplier of item delivery services in order for the supplier of item delivery services to be included in the advice provided.

36. The computer-readable medium of claim 34, further comprising certifying the supplier of the item delivery services as being a reputable enterprise.

37. The computer-readable medium of claim 31, further comprising utilizing at least one of regular mail, e-mail, facsimile, internet, and an interactive voice response computer-readable medium in providing consumer assistance.

38. The computer-readable medium of claim 31, further comprising charging a fee to provide consumer assistance.

39. The computer-readable medium of claim 38, wherein charging the fee comprises at least one of billing the consumer, debiting the consumer's checking account, debiting the consumer's credit card account, debiting the consumer's debit card account, and receiving cash from the consumer.

40. The computer-readable medium of claim 31, wherein the assistance request is limited to assistance regarding interfacing with an item delivery system.

41. The computer-readable medium of claim 40, wherein the item delivery system comprises the United States Postal Service.

42. The computer-readable medium of claim 40, wherein an item delivered in the item delivery system comprises at least one of a mailpiece, a United States Postal Service Priority Mail package, and a United States Postal Service Express Mail Package.

43. The computer-readable medium of claim 41, wherein providing consumer assistance includes utilizing a video.

44. The computer-readable medium of claim 43, further comprising providing the video over the Internet.

45. The computer-readable medium of claim 43, further comprising requiring the consumer to view the video before allowing the consumer to speak to a consumer services representative.

46. A method for providing consumer assistance regarding interfacing with an item delivery system, the method utilizing at least one of regular mail, e-mail, facsimile, internet, and an interactive voice response method in providing consumer assistance, the method comprising:
receiving an assistance request from a consumer, the assistance request comprising at least one of a request for advice from an expert, a request for advice from another consumer, and a request for advice on an available service;
providing advice from an expert if the assistance request comprises the request for advice from the expert, wherein providing advice from an expert further comprises providing advice on how to send items through the item delivery system at a reduced cost;
providing advice from another consumer if the assistance request comprises the request for advice from another consumer, wherein providing advice from another consumer further comprises utilizing at least one of an electronic bulletin board and an Internet chat room;
providing advice on an available service if the assistance request comprises the request for advice on an available service, wherein providing advice on the available service further comprises providing information on a supplier of item delivery services, receiving a fee from the supplier of item delivery services in order for the supplier of item delivery services to be included in the advice provided, and certifying the supplier of the item delivery services as being a reputable enterprise;
charging a fee to provide consumer assistance, wherein charging the fee comprises at least one of billing the consumer, debiting the consumer's checking account, debiting the consumer's credit card account, debiting the consumer's debit card account, and receiving cash from the consumer;
wherein an item delivered in the item delivery system comprises at least one of a mailpiece, a United States Postal Service Priority Mail package, and a United States Postal Service Express Mail Package; and
wherein providing consumer assistance include utilizing a video provided over the Internet and requiring the consumer to view the video before allowing the consumer to speak to a consumer services representative.
